(19) United States
(12) Patent Application Publication
(10) Pub. No.: US 2023/0080317 A1
(43) Pub. Date: Mar. 16, 2023

(54) Drone Integrated Box System (D.I.B.S)

(71) Applicant: Michelle Williams Prescott, Miami, FL (US)

(72) Inventor: Michelle Williams Prescott, Miami, FL (US)

(21) Appl. No.: 17/830,974

(22) Filed: Jun. 2, 2022

Related U.S. Application Data
(63) Continuation of application No. 17/093,259, filed on Nov. 9, 2020.

(51) Int. Cl. G05D 1/00; B64C 39/02

(52) U.S. Cl. CPC G05D 1/0022; B64C 39/024; B64C 2201/122; B64C 2201/18; B64C 2201/128

(57) ABSTRACT

A secure, personalized, and locatable container for residential, commercial, industrial, and military use that is capable of interfacing with Unmanned Aerial Vehicles (UAVs) and Unmanned Ground Vehicles (UGVs) for the purpose of sending and receiving mail and parcels. The container is stationary when installed but can be uninstalled and easily transportable to an alternate location for re-installation. The present invention of the container and proprietary communications protocol provides the benefit of touchless, secure, and verifiable parcel service anywhere in the world.

This is a continuation of utility patent application Ser. No. 17/093,259, titled Drone Integrated Box Systems (D.I.B.S.).

### BACKGROUND OF THE INVENTION

### Field of the Invention (Technical Field)

The present invention relates generally to security lock boxes and more particularly to security lock boxes that have drone communications features, inclusive but not limited to a landing pad and entry door that allows the box to send and receive envelopes and parcels securely with confirmation via drone or autonomous vehicle delivery.

### BACKGROUND

The statements in this section merely provide background information related to the present disclosure and may not constitute prior art.

COVID-19 resulted in an increase in consumer demand for secure “touch-less” or “contact-less” products and services. Drones are now being used more to deliver packages and autonomous vehicles are being tested for curbside mail and small parcel delivery.

Currently, the attempts to address touch-less deliveries utilizing Drones involves either using landing pads, large centrally located collection boxes, or simply the ground.

DIBS augments drone and autonomous vehicle deliveries of envelopes and small parcels by eliminating the need for delivery drivers and mail carriers for letters and small parcels to allow for the seamless exchange of mail between sender and receiver anywhere in the world.

In addition to the above, DIBS provides users with secure and verifiable send/receive receipts of letters and parcels.

### SUMMARY OF THE INVENTION

The present invention is directed toward the areas of drone and autonomous delivery of mail and packages. DIBS is a new product and technological service meant to augment drone and autonomous vehicle deliveries. The introduction of DIBS is meant to eliminate the need for delivery drivers and mail carriers for letters and small parcels.

Just as the advent of email meant direct delivery of messages to an individual rather than to a physical address, and cell phones allowed us to contact a person directly rather than have to phone a specific location; Drones with DIBS' interface support direct delivery of letters and small parcels anywhere in the world securely and with two-way encrypted confirmation to both sender and receiver.

Drones are being increasingly integrated into society for more and more common uses. Drones, like people, can circumnavigate the globe. The objective of this invention is to provide any person who wants to receive letters and/or parcels with a DIBS number; a unique identifier that can be input into a new or existing personal DIBS container anywhere in the world. This personalized number, maintained by the user in a secure manner, has the capability of allowing a drone to locate and make confirmed contact with a specific person in order to deliver their mail to a personal secure repository no matter where they are located. The DIBS container is lightweight, remotely programmable, and easily transportable, eliminating the need for intermediary mail processing and facilitating direct, secure, and confirmed delivery by drone, autonomous vehicle, or human.

DIBS can be used in residential, industrial, commercial, and military settings.

The DIBS unit is secure and made of ballistic grade moldable Kevlar. The Kevlar is molded into shape and provides the DIBS box with a level of protection against tampering as well as the ability to resist heat, cold, water, and impact.

Power for the DIBS container is rechargeable. Additional sources of power can be obtained through a backup battery source connected to a residential or commercial unit.

The DIBS unit is transportable or re-addressable and each has a location signal, camera, sentry abilities, and metering. Container openings may have rubber flashing, stiff bristles, or other methods known to those in the art, to prevent contaminants, debris, or water from entering the unit housing.

Each user has a unique identifier, referred to as a DIBS number that remains with them for the duration of their use of a DIBS container.

The DIBS box remains closed unless accessed by the user's DIBS number. The DIBS number is a unique identifier for the user, which can be programmed into any DIBS box or provided to a user approved sender.

Secure and confirmed access is achieved via AES 256-bit encrypted communication between the DIBS box and the drone.

Engagement and disengagement communication commands between the DIBS container and UAVs or UGVs is facilitated wirelessly via the DIBS proprietary secure protocol and is supported by sensors, antenna, and location beacons of a type known to those in the art.

UAVs and UGVs can execute a payload transfer sequence by either tethering the payload to a cable and raising it from or lowering it into the DIBS container. Depending upon the size of the drone, it can land directly on the DIBS container, which is equipped with landing pads on the sides of the top surface of the container allowing the drone to land substantially flush on top of the DIBS container.

It will be appreciated by those of skill in the art upon reading this disclosure that various alterations and modifications to the embodiment particularly disclosed can be made within the scope of the invention. Related objects and advantages of the present invention will be apparent from the following detailed description of an illustrative embodiment of the invention, reference being made to the accompanying drawings. This summary is provided merely to introduce certain concepts and not to identify key or essential features of the claimed subject matter.

### BRIEF DESCRIPTION OF THE DRAWINGS

For a more complete understanding of this disclosure and its features, reference is now made to the following description, taken in conjunction with the accompanying drawings. Present embodiments are shown in the drawings. The components in the figures are not necessarily to scale, emphasis instead being placed upon illustrating the principles of the invention. It should further be appreciated however, that the invention is not limited to the precise arrangements and instrumentalities shown. In the figures, like reference numerals designate corresponding parts throughout the different views.

FIG. 1 is a top plan view of the closed DIBS top entry hatch, one of the three methods for entry to the unit.

FIG. 2 is a top plan view of the open DIBS top entry hatch.

FIG. 3 is a front elevation view of the DIBS container.

FIG. 4 is dual-elevation rear view of the DIBS container featuring the open- and closed-door functionality of the DIBS container.

FIG. 5 illustrates an Unmanned Aerial Vehicle tethered delivery sequence when integrated with a DIBS unit.

FIG. 6 illustrates the functionality of the DIBS network, with regard to understanding how drones and unmanned ground delivery vehicles interface with the DIBS unit and network to facilitate the delivery of letters and packages as well as provide sentry service.

### DETAILED DESCRIPTION OF THE INVENTION

The invention will now be described in detail hereinafter with reference to the accompanied drawings. While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for illustrating to one skilled in the art to variously employ the inventive arrangements in virtually any appropriately detailed structure. Further, the terms and phrases used herein are not intended to be limiting but rather to provide an understandable description of the product and service invention.

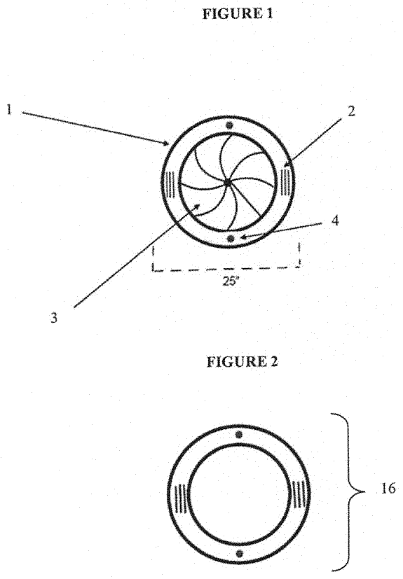

Identical reference numerals are used for like elements of the invention or elements of like function. For the sake of clarity, only those reference numerals are shown in the individual figures, which are necessary for the description of the respective figure. For purposes of this description, the terms “top”, “bottom”, “left”, “right”, “front”, “rear”, “vertical”, “horizontal”, and derivatives thereof shall relate to the invention as oriented in FIGS. 1 through 6.

Although described herein as a box with a drone landing pad, the invention can be realized when an Unmanned Aerial Vehicle (UAV) or an Unmanned Ground Vehicle (UGV) interacts with it and is provided with secure and confirmed access to either leave or retrieve items contained within the unit.

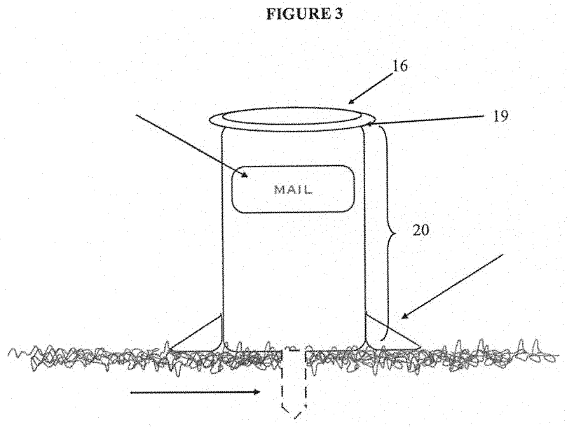

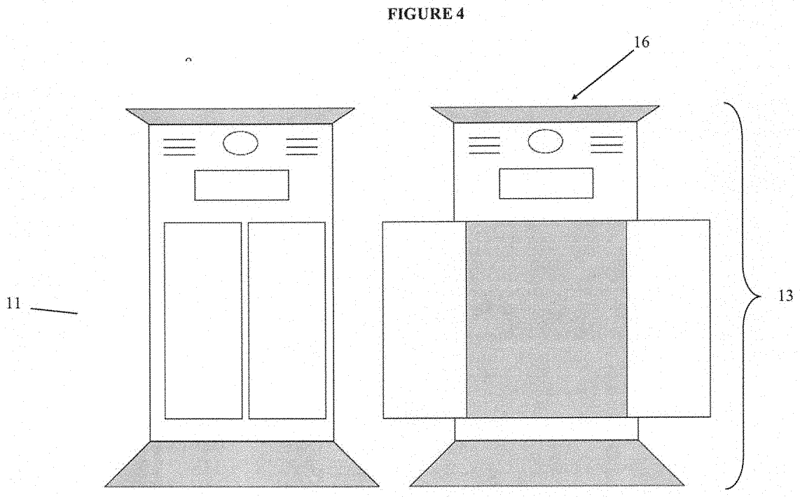

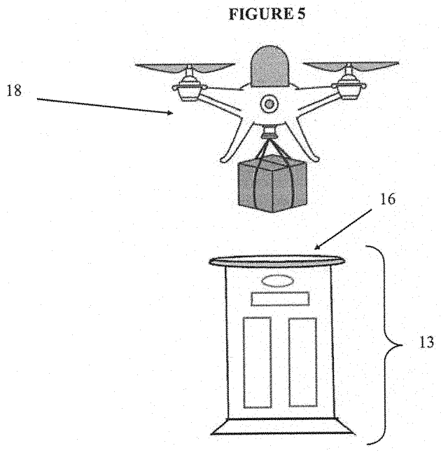

FIGS. 1-2 show the top entry hatch 16 having a circular flat shape, when viewed from above. Referring to FIG. 1, the blade housing ring 1 stores the retractable galvanized steel blades 3 in the closed position. FIG. 2 alternatively shows the open position of the entry hatch with the galvanized steel blades 3 stored in the blade housing ring 1. The galvanized steel blades 3 open and close upon remote command through the command & control center 17 (FIG. 3), or manual input using the DIBS user number registered to the DIBS box through control panel 9 (FIG. 4). FIG. 1 shows the drone skid pads 2 for UAVs 18 (FIG. 6) to interact with and utilize to allow a substantially flush landing. The beacon lights 4 and bullnose antenna arrays (not shown) also engage with UAVs 18 to provide directional support for a coordinated and smooth landing.

FIG. 3 shows the frontal view of the DIBs container 13 which features a front entry hatch 5, which is intended to be used as a receptor for mail delivered curbside by autonomous vehicle or human for walk up delivery services. The top aerial entry hatch 16 (FIG. 1) is attached to the bottom container 20 via a latching mechanism 19 sufficient enough to maintain a secure, water-tight, tamper proof seal. Similar to the method of operation for the galvanized retractable blades 3 on the top entry hatch 16, access is gained by way of the command & control center 17 or manual input using the DIBS user number registered to the DIBS box through control panel 9. The bottom container 20 is equipped with stabilizers 6 as well as a below ground spike 7 for stabilization. Once installed utilizing the underground stake 7 and side stabilizers 6, the DIBS container 13 is meant to function as a stationary unit.

FIG. 4 is a rear view of the DIBS container 13 that enumerates the features of the DIBS container. The control panel 9 is the central hub of operation for manual programming of the DIBS container 13. Control panel 9 interfaces with the surveillance camera 8 which further provides sentry services by way of remote sensing capabilities such as, but not limited to, visual imaging that can be adjusted to the desired field of view. DIBS container 13 will maintain video footage of each transaction and can be programmed to record all interactions between it and other systems/users. DIBS container 13 also features a dual voice communications and ventilation system 10 to avoid heat build up and provide a communication system. FIG. 4 further shows the last delivery method for DIBS container 13 through the panel doors 11 that swing outward for access. Although not shown, control panel 9 further interfaces with a close-in vehicle to DIBS authentication system; antitamper/theft deterrence system; long-range and close-in scalable power radios; power and Internet interface; voice and video interface; local battery back-up; perimeter security/sentry capabilities; digital metering/measuring scale; and a re-addressable option. An added feature of DIBs is residential security. DIBS can also function as a smart home appliance and integrate with the home's security systems. As such, the device could support 911 notification in case of an emergency.

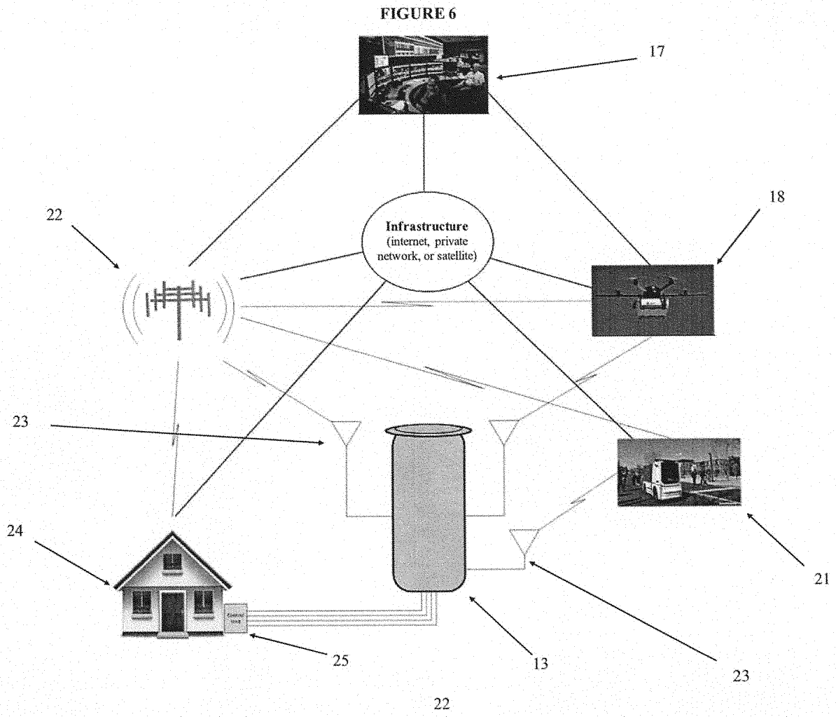

FIG. 5 illustrates the proposed delivery method by UAV 18 to DIBS container 13 with parcel drop off through the top entry hatch 16.

FIG. 6 illustrates the communications infrastructure whereby the command- and—control center 17 can communicate with the 4G/5G Backhaul Antenna 22, the DIBS control unit 13 at the residential site 24, UGVs 21, and UAVs 18. The 4G/5G Backhaul Relay 22 is comprised of the Wide Area Antenna (not shown) that shakes hands with smaller DIBS user deployed and UAV/UGV operator deployed smaller cell sites. The 4G/5G network is Internet enabled and its purpose is to relay commands and information between the DIBS container 13, and the UAV 18 and UGV 21. The DIBS container has antenna 23 that allows it to relay send/receive messages between it and the UAV/UGV.

### Command and Control Center

Operationally, the function of the command-and-control center 17 is to direct traffic and confirm links between DIBS 13 and UAGs 18 and UGVs 21. The command-and-control center 17 will also log connections (monitoring) so there is a recording for security, quality, and legal purposes. It will provide updates, patches, capability upgrades, remote user support, tech support, etc. The DIBS program has checks and balances that confirm validity of both sender and receiver as well as a communications operational check function that will ensure that there are no issues impeding completing the payload transfer from the UAV/UGV in a secure manner. It will be necessary to provide tech support for DIBS. Setup and monitoring of the DIBS container will be needed and provided as a function of the command-and-control center 17. It will also be necessary to meter DIBS services for online sales vendors, such as Amazon, and others that require this support. If DIBS has a failure and remote technical assistance is required to ensure successfully delivery, a wired tail-circuit from DIBS 13 to the home internet services will allow this service as a pass-through back to the DIBS command-and-control 17 an alert of request for technical support.

### Infrastructure (Internet, Private Network, or Satellite)

Further referencing FIG. 6, this is a notional representation of the infrastructure that can and will likely be in place to ensure end-to-end connectivity between DIBS container 13 and its end-points. This will most likely be a combination of DIBS' owned infrastructure and public infrastructure. Connection via the internet is one possible part of this connection in which DIBS may securely tunnel across the internet to different end-points. Other possibilities to facilitate this connection are satellite, backhaul or private networks. Some or all of DIBS communication standards will be implemented via DIBS designed and wholly owned infrastructure. This infrastructure can be both wireless and wired infrastructure. The 4G/5G Backhaul Antenna 22 could be used to communicate across metropolitan and rural areas.

### 4G/5G Backhaul Relay

Further referencing FIG. 6, there needs to be a means to get the data from the DIBS container 13 back to the command-and-control center 17. This can be wired from the DIBS container 13 directly to pre-existing service providers at the residence such as Cox, Comcast, or Verizon; via cell phone towers (5G/4G) with direct communications from DIBS container 13 to a macro cell antenna or small cell antennas; or from DIBS to a small or micro antenna. The method of backhauling the data from the DIBS container 13 to the command-and-control center 17 will need to happen with little delay and routed over a private network or via an existing service provider.

Further referencing FIG. 6, the backhaul of a network links the core infrastructure to other subnetworks. The 4G/5G network is linked to the wired network through the backhaul. For DIBS, the first approach is to establish a zone of communication that will be the gateway to the core network that will allow communication between the command-and-control center 17, the DIBS residential connection 24, and the DIBS container 13. The second approach to enable informational relay is to utilize a residence's broadband connections from the control unit back to the command-and-control center 17. In this instance, DIBS's VPN would ride on the existing service connection.

### Residential DIBS Control Unit

Further referencing FIG. 6, the DIBS control unit 25 that is affixed to the residence 24 is the brains for the DIBS container 13. This is separate from the curbside receptacle 13 and would be mounted to the outside of the residence 24 and plugged into a circuit panel. The control unit 25 provides wireless connection to other access points such as macro cell towers and small cell towers to communicate with the DIBS command-and-control center 17 in situations where a direct broadband connection is not available.

### IPV6 Address

Further referencing FIG. 6, the DIBS container 13 will maintain an IPV6 gateway address. Additional IPV6 addresses will also be assigned to each of the home residences and this ID will map a delivery transaction to a resident. These IPV6 addresses will be auto-generated by the DIBS container 13 and command-and-control center 17. See example below.

### Telemetry Data

Further referencing FIG. 6, the DIBS container 13 will transmit its fixed curbside location to an on-approach delivery vehicle, UAV 18, and UGV 21. This telemetry will consist of the precise GPS location of the DIBS as well as the range, elevation and bearing of the on-approach vehicle.

### Authentication

Further referencing FIG. 6, between the DIBS container 13 and the delivery vehicle and/or human-in-the-loop, a unique security code will be exchanged between the DIBS control panel 9 and the user or automated delivery vehicle. This authentication code could be delivered from the delivery service (Amazon, FedEx, etc.) to the DIBS command-and-control system 17 and then to the residential DIBS control unit 25. When this code is exchanged between the residential DIBS system 25 and the delivery vehicle or delivery person, access to the DIBS container 13 will be granted, picture of the delivery taken and timestamped and sent to the delivery service (i.e. Amazon, FedEx, etc.), the resident, as well as to the DIBS command-and-control center 17 for record keeping purposes. The DIBS unit 13 will also send this to the resident via email, text message or DIBS limited storage access.

### Wired Connection

Further referencing FIG. 6, there will need to be a fiber link between the control Unit 25 and the DIBS container 13 along with power. A wired connection would also exist between the box and the home's broadband connection (internet service provider).

### Power Supply/Battery Backup

Further referencing FIG. 6, there is a backup battery inside of the control Unit 25 to withstand power disruptions (not shown on drawing).

### Internet Gateway/COMSEC

Further referencing FIG. 6, the DIBS system will have an internet gateway address and utilize various levels of communications security to thwart security intrusion (not shown on drawing).

### Anti-Tamper

Further referencing FIG. 6, access to the control unit can be via a RJ45 port, USB or other interface to access a small secure kernel that allows the home/box owner to configure key parameters. This setup can also be done by tech support at the DIBS command-and-control center 17. If anyone who is unauthorized tries to open the control unit, the device will cease to function and will require onsite support to restore the unit (not shown on drawing).

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms box and container are used interchangeably. The terms “comprises” and/or “comprising”, when used in this specification, specify the presence of stated features, integers, steps, operations, elements, and/or components, but do not preclude the presence or addition of one or more other features, integers, technology, steps, operations, elements, components, and/or groups thereof.

The corresponding structures, materials, technology, acts, and equivalents of all means or step plus function elements in the claims below are intended to include any structure, material, technology, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1-20. (canceled)

21: A secure, personalized, locatable, and transportable receptacle comprising:
a top body portion with an entry hatch adapted to receive delivery of a variety of parcels, objects, and non-standard sized mailing items;
a bottom body portion attached to the top body portion, the bottom body portion having an inner cavity;
a slot disposed in the front bottom body portion adapted to receive standard sized mail through the slot and depositing the mail into the inner cavity of the bottom body portion;
at least one door in the bottom body portion, the door adapted to provide access for retrieval of mail, parcels, and objects delivered through one of the top entry hatch and the slot.

22: The receptacle of claim 21, wherein the bottom body portion contains at least one stabilizing support fixture.

23: The receptacle of claim 21, wherein the bottom body portion includes a detachable stake mounted to the bottom body portion, the detachable stake adapted to be inserted into the ground for stabilisation of the receptacle.

24: The receptacle of claim 21, wherein the bottom body portion comprises a computer-implemented encrypted communications system communicating with a control panel through a fiber link to a command-and-control center;
the receptacle further comprising:
a solar rechargeable power supply mounted on the top body portion; and
a local backup battery source associated with the control unit.

25: The receptacle of claim 21, wherein the receptacle is comprised of a lightweight, moldable, durable, ballistic grade material.

26: The receptacle of claim 21, wherein the receptacle is adapted to facilitate direct, secure, and confirmed delivery by Unmanned Aerial Vehicles (UAVs) and Unmanned Ground Vehicles (UGVs).

27: The receptacle of claim 21, wherein the top body portion of the receptacle comprises:
a circular landing ring with skid pads;
beacon lights and antenna adapted to communicate with UAVs, UGVs, and the control panel;
an airtight, waterproof latching mechanism adapted to connect the top body portion with the bottom body portion;
an entry hatch below the circular landing ring that leads into the inner cavity of the bottom body portion;
the entry hatch further comprising:
a plurality of retractable galvanized steel blades;
matching solar panels generating power for the receptacle attached to the steel blades; and
a communications system controlling the opening and closing of the blades, the blades operated via remote communications through the receptacle control panel and a command-and-control center.

28: The receptacle of claim 21, wherein the bottom body portion of the receptacle comprises:
an inner cavity adapted to receive parcel services;
a front slot with a retractable hatch, the retractable hatch controlled via remote communications through the receptacle control panel and a command-and-control center;
a voice communications system overlaid on a ventilation system;
at least one door on the back body of the receptacle with an electronic lock synched to a control panel communications system of the receptacle;
an inner power source containing a backup local battery source; and
a control panel with a communications terminal.

29: The receptacle of claim 28, wherein the bottom body portion comprises:
at least one first outer camera configured to verify receptacle user identity; and
at least one second outer camera configured to send digital confirmation to the receptacle control panel communications system.

30: The receptacle of claim 24, further including the control panel configured to analyze information recorded by at least one first and second outer camera and activate the receptacle control panel communications terminal to open back body portion panel doors based on the analyzed information.

31: The receptacle of claim 31, wherein the control panel is further configured to analyze information recorded by the at least one first and second outer camera, and in response to obtaining face characteristics of a user based on the analyzed information, issue the receptacle opening instruction to the back body portion panel doors.

32: The receptacle of claim 32, wherein the control panel is further configured to be remotely programmable, and has a location signal, camera, and sentry and metering capabilities.

33: The receptacle of claim 32, wherein the control panel is further configured with a communications protocol compromising a secure digital platform sending/receiving communications and commands performed via encryption and confirmed by sender and recipient.

34: The receptacle of claim 31, the control panel is further configured with a proprietary communications protocol that is personably addressable via a unique receptacle user number and is readdressable for additional users.

35: The receptacle of claim 31, the control panel further comprising an anti-tampering sensor connected to the control panel, the anti-tampering sensor operable to detect tampering of the receptacle.
